(19) United States
(12) Patent Application Publication
(10) Pub. No.: US 2002/0096454 A1
(43) Pub. Date: Jul. 25, 2002

(54) Part separator having multiple inlets and method of supplying wet chips through multiple inlets

(76) Inventors: William D. Nemedi, Paw Paw, MI (US); Robert J. Nemedi, Kalamazoo, MI (US)

Correspondence Address: James P. Zeller, Esq., Marshall, O'Toole, Gerstein, Murray & Borun, 6300 Sears Tower, 233 South Wacker Drive, Chicago, IL, 60606-6402, US

(21) Appl. No.: 09/769,659

(22) Filed: Jan. 25, 2001

(51) Int. Cl. B07B 4/02

(52) U.S. Cl. 209/137; 209/147

(57) ABSTRACT

A parts separator is provided for separating undesired heavy material from wet chips. The parts separator is adapted to be attached to a centrifugal separator, and includes a first chute member having a top portion and a bottom portion and including spaced open first and second chute ends. The first end is adapted to receive wet chips to be centrifuged and the second end is adapted to be connected to a centrifugal parts separator. The parts separator also includes a heavy material drop out opening disposed in the first chute member bottom portion. The first chute member top has at least one opening disposed therein. The parts separator also includes a second chute member having spaced open first and second ends. The first end of the second chute member is adapted to receive wet chips to be separated and the second chute member end is attached to the first chute member at the location of the opening in the first chute top portion. Wet chips in the second chute member can pass through the opening in the top portion and pass into the first chute member.

### FIELD OF THE INVENTION

The present invention is directed to an improved parts separator for use with a centrifugal separator and more particularly to a parts separator having a plurality of air and/or wet chip material openings.

### BACKGROUND OF THE INVENTION

It is known to have systems for separating fluids from other materials such as the separation of metal chips generated in the course of a machining operation from lubricating oils. An example of such a system is shown and disclosed in U.S. Pat. No. 5,106,487, the entire disclosure, drawings and claims of which are incorporated herein by reference. The 487' patent illustrates a system for separating undesired, heavy metal parts from wet chips prior to the entry of the wet chips into a centrifugal separator where lubricating oil is separated from the chips. While the type of materials separation system disclosed in the 487' patent is satisfactory in many applications, it has been found, however, that with some applications, the parts separator is not entirely satisfactory.

Applications exist where wet chips are to be gathered from multiple points of origin with the wet chips being conveyed to a single parts separator prior to entry of the wet chips into a centrifugal separator. In some instances, it may be desirable or necessary to have the wet chips from one source pass to the parts separator by a mechanical conveyor or the like where heavy, unwanted metal pieces, e.g., machine screw, tool, etc. can be separated out from the wet chips to be centrifuged. In other instances, however, wet chips from a source of origin may be pneumatically delivered to the parts separator in a fluid stream such as disclosed in Nemedi application U.S. Ser. No. 09/504,764 filed Feb. 15, 2000, the entire disclosure, drawings and claims of this are incorporated herein by reference. In this pneumatic wet chip delivery system, it is contemplated that heavy unwanted pieces could, if desired, be removed from the wet chips to be centrifuged at the location of the source of origin of wet chips, e.g., a machine tool site where the wet chips are generated. More specifically, in the pneumatic wet chip delivery system, unwanted heavy pieces are removed by passing the wet chips through a parts separator prior to the wet chips entering the pneumatic fluid wet chip flow. In other instances, however, it is desired to convey the wet chips and heavy parts pneumatically to a parts separator which is attached directly or indirectly to a centrifugal separator. This is particularly desired in cases where wet chips are conveyed pneumatically or pneumatic and/or mechanically from a plurality of sources to a parts separator. Accordingly, it is desired to have a parts separator with multiple openings to allow for multiple sources of pneumatic fluid and/or wet chips to enter the parts separator.

Further, in conventional wet chip separation systems presently available, a parts separator often includes a rotary air lock assembly which is located at the location of the wet chip inlet chute. The air lock assembly serves to preclude pneumatic fluid from entering the parts separator at the location of the wet chip entry chute. Accordingly, upon actuation of the centrifuge separator, to which the parts separator normally is attached, a vacuum is created in the parts separator and pneumatic fluid, i.e., air, is pulled into the parts separator primarily through the heavy material drop out chute. While this source of air is sufficient in many applications, in instances where wet chips are pneumatically conveyed to the parts separator, other air or fluid sources, aside from the air entering the centrifugal separator through the parts separator drop out chute, are

Accordingly, what is desired is to have a parts separator adapted for receipt of wet chip materials through multiple inlet conduits. Additionally, it is desired to have a parts separator having a plurality of openings adapted to supply wet chips and/or pneumatic fluid to and through the parts separator.

### SUMMARY OF THE INVENTION

The system and apparatus of the present invention serve to achieve the advantages desired for a wet chip parts separator.

Briefly, the invention disclosed and claimed herein relates to a parts separator which is adapted to include a plurality of inlet chutes for material and/or air whereby heavy parts can be separated from the wet chips to be centrifuged at the location of a drop out chute while wet chips pass to a centrifugal separator where separation occurs resulting in dry chips and fluid. Additionally, having multiple entry chutes in the parts separator provides for multiple pneumatic fluid entry points in the parts separator which particularly, in the instance where wet chips are pneumatically delivered to a centrifugal separator, is desirable. Accordingly, the present invention provides a parts separator which includes a heavy material drop out chute and multiple entry chutes for the entry of wet chips, pneumatic fluid or a mixture of wet chips and pneumatic fluid.

These and other features, advantages, and objects of the present invention will be further understood and appreciated by those skilled in the art by reference to the following specification, drawings, and claims.

### BRIEF DESCRIPTION OF THE DRAWINGS

FIG. 1 shows a side, fragmentary view of a prior art parts separator connected at one end to a conventional wet chip conveyor feeder and at the opposite end to a conventional centrifugal separator;

FIG. 2 shows a fragmentary, side section view of a parts separator embodiment of the present invention having multiple pneumatic fluid and wet chip inlets and including a rotary air seal lock located in one wet chip material inlet chute; and

FIG. 3 shows a fragmentary, side section view of the parts separator embodiment of FIG. 2 with the rotary air seal of FIG. 2 moved outside of the parts separator.

### DETAILED DESCRIPTION

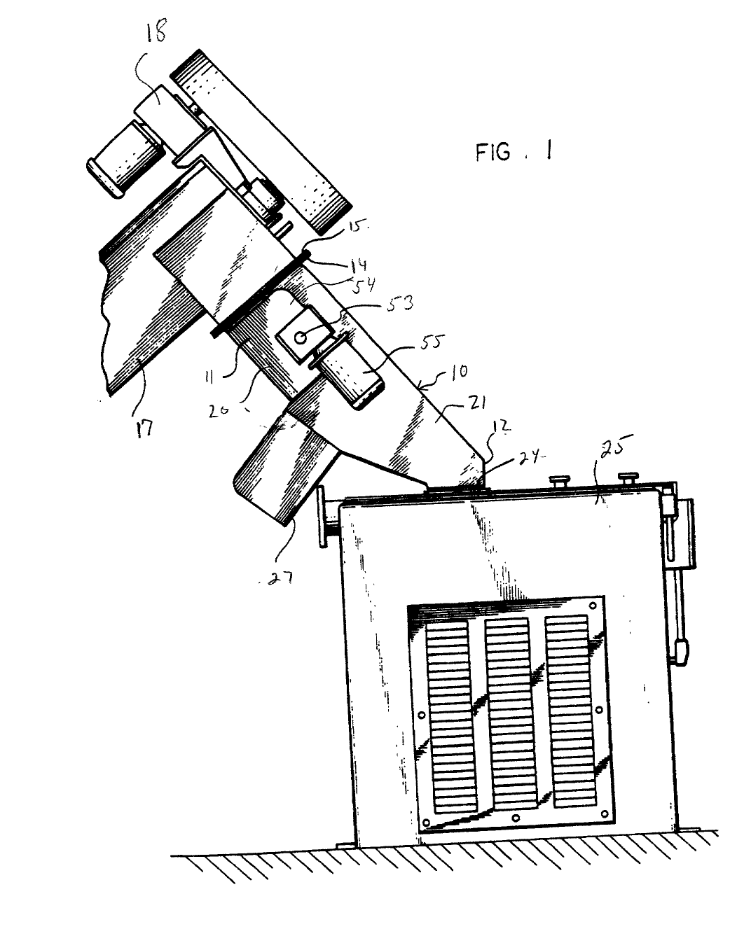

Referring to FIG. 1, parts separator 10 has ends 11, 12. Material receiving end 11, flanged at 14, is connected to flange 15 of a conventional mechanical conveyor such as an auger type conveyor 17 having a drive assembly 18. Conveyor 17 conveys both wet chips to be separated and heavy metal pieces to parts separator 10.

The prior art parts separator device 10 illustrated in FIG. 1 and described in detail in the above-referenced '487 patent comprises a first chute member 20 which extends in a first direction from wet chip receiving end 11 and a second chute member 21 which extends in the first direction and is positioned contiguous to a heavy piece drop out opening located in the bottom wall 19 at the exit end of first chute member 20. A drop out chute 27 is positioned below heavy material drop out opening.

End 12 ofpart separator 10 includes flange 24 which is illustrated as being connected to a complementary flange located on the top wall of a conventional centrifugal separator 25 such as illustrated and offered for sale by Intersource Recovery Systems, Inc., Kalamazoo, Mich. and shown in Inter-Source's catalog entitled “Chip Processing,” copyrighted in 1997.

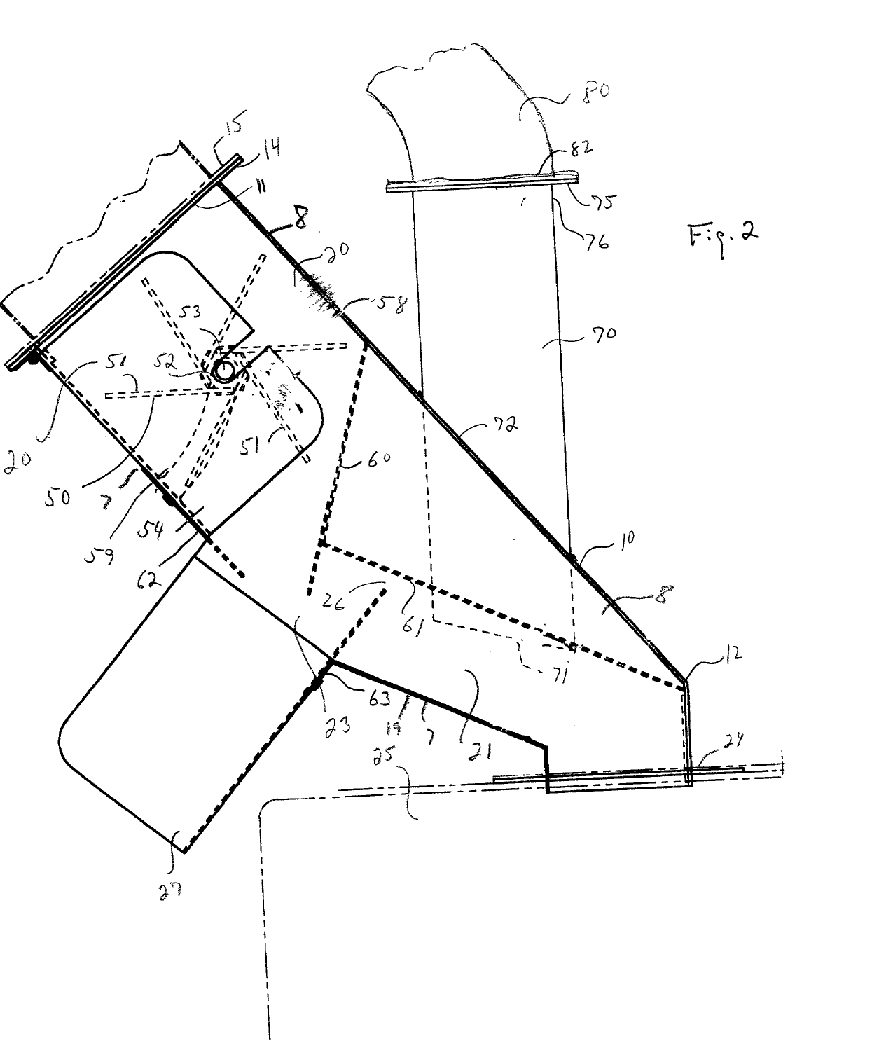

A rotary air-seal assembly 50, as illustrated in FIG. 2, is disposed in first chute member 20. Assembly 50 comprises a plurality of equally spaced, relatively stiff, but flexible paddle wheel blades 51 connected to hub 52. Hub 52 is positioned on rotatable shaft 53 connected to suitable bearings, located in the side walls 54 of first chute member 20. Shaft 53 is connected to motor 55 or other suitable drive means which serve to drive blades 51 in a counterclockwise direction. The outer edges of the blades are spaced a short distance from chute walls 58, 59 such that while the blades serve to act as a seal to some extent, they also serve to contact material in first chute member 20 and assist it as it slides along the bottom wall 59 of first chute member 20.

Baffle plates 60, 61, illustrated in FIG. 2, also are disposed within parts separator 10 to assist in directing materials through parts separator 10. Adjustably mounted baffle plates 62, 63 also are provided to increase and decrease the area surrounding exit material drop out opening 23 in first chute member 20 and the size of the area in entrance opening 26 in second chute member 21.

FIG. 2 illustrates a parts separator having the structure of the separator illustrated in FIG. 1 with the addition however of a third inlet chute member 70. Chute member 70 includes an end 71 which intersects with and is attached or joined, for example by welding, to the top wall 72 of second chute member 21. First chute member 10 is shown as comprising a top portion 8 which includes chute top 72 and a portion of the side walls 54 extending from the top wall. Member 10 also includes a bottom portion 7 which includes chute bottom 19 and a portion of side walls 54 extending from the chute bottom and terminating as the side walls extending from the top wall 72 of top portion 8.

Chute member 70 includes flange 75 located at its remaining end 76. Flange 75 is adapted to connect to flange 82 of a pneumatic wet chip conduit member 80, such as shown and disclosed in our pending application U.S. Ser. No. 09/504,480 filed Feb. 15, 2000. Conduit member 80 serves to pneumatically convey wet chips, from which heavy parts already have been separated at the location of the tool machine site where the wet chips are generated prior to the wet chips entering pneumatic conduit 80. The wet chips from conduit 80 enter chute member 70 and drop into second chute member 21. In chute member 21, the wet chips that entered separator 10 from conveyor 17 mix with wet chips that entered separator 10 through chute member 70. The combined wet chips pass into centrifugal separator 25 where they are centrifuged resulting in dry chips and fluid. Similarly, if desired, the opening in end 76 of chute member 70 could be open to the atmosphere with the opening serving as a source of pneumatic fluid entering centrifugal separator 25. Further, in place of an auger type conveyor 17, the wet chips could be conveyed by a pneumatic conveyor system as described in our aforementioned patent application No. 09/504,580.

If desired, additional chute members 70 can be attached to parts separator 10. Each of these additional chute member can be connected to a pneumatic fluid conduit such as conduit 80, or the chute member may be open to the outside air at chute end 76 to provide multiple fluid openings in part separator 10. When centrifugal separator 25 is actuated, fluid, such as air, will be pulled into the parts separator through drop out openings 23 as well as the opening at end of 71 of a chute member 70. In the event unwanted heavy parts have not been removed at a machine site, the chute, such as 80, can be attached to a chute 70 disposed in the top wall portion of the first member 20 whereby the wet chips and heavy parts ass over drop out opening above chute 27 when heavy parts drop out the drop out opening.

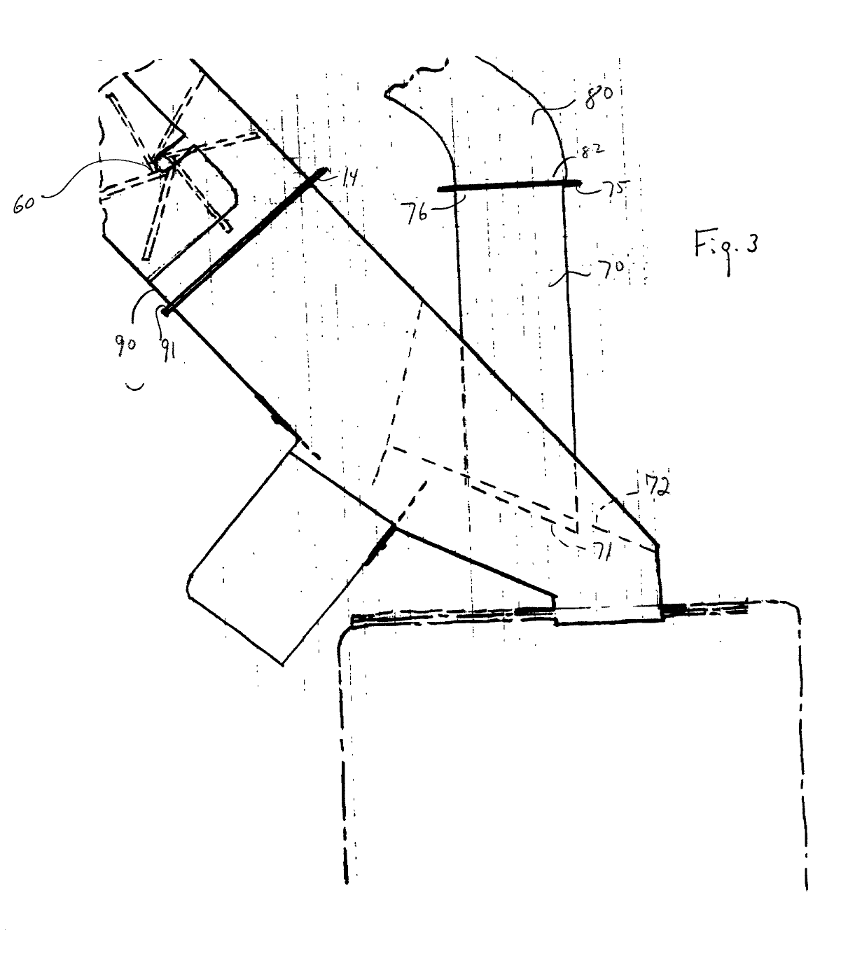

FIG. 3 shows the embodiment of FIG. 2 save the rotary air lock assembly 60 has been moved outside parts separator 10. Airlock assembly 60 in this embodiment is disposed in chute member 90. Chute member 90 has flanges 91, only one of which is shown at each end of member 90. A flange 91 is connected to flange 14 of parts separator 10 while the remaining flange 91 is attached to flange 15 of conveyor assembly 17.

While the present invention has been described with reference to the various embodiments shown, it will be apparent to those of ordinary skill in the art that changes, additions and/or deletions may be made to the disclosed embodiments without depicting from the spirit and scope of the invention.

1. A parts separator for separating undesired heavy material from wet chips, said parts separator being adapted to be attached to a centrifugal separator, said parts separator comprising:
a first chute member having a top portion and a bottom portion and including spaced open first and second chute ends;
said first end being adapted to receive wet chips to be centrifugal and said second end being adapted to be connected to a centrifugal parts separator;
a heavy material drop out opening disposed in said first chute member bottom portion;
said first chute member top having at least one opening disposed in said top portion; and
a second chute member having spaced open first and second ends, said first end of said second chute member being adapted to receive wet chips to be separated and said second chute member end being attached to said first chute member at the location of said opening in said first chute top portion whereby wet chips in said second chute member are adapted to pass through said opening in said top portion and pass into said first chute member.

2. A parts separator in accordance with claim 1 wherein said heavy material drop out opening in said first chute member is located a first distance from said first end of said first chute member and said opening in said top portion is located a second distance from said first end of said chute member and said second distance which is greater than said first distance whereby wet chips entering said first chute member from said second chute member drop into said first chute member between said heavy material drop out opening and said second end of said first chute member.

3. A parts separator in accordance with claim 1 wherein said first end of said second chute member is attached to a wet chip delivery conduit.

4. A parts separator in accordance with claim 1 wherein said first end of said second chute member is open to serve as a source of pneumatic fluid to the centrifugal separator whereby fluid is directed through said second chute member into said first chute member.

5. A parts separator in accordance with claim 1 wherein said first chute member has a plurality of spaced openings in said top portion,
a plurality of second chute members each adapted to receive wet chips, each second chute member including a first open end and a second open end spaced from said second member chute first end; and
said second chute members each being attached to said first chute member at the location of an opening in said first chute member top portion whereby wet chips in said second chute members are adapted to pass into said first chute member.

6. A parts separator in accordance with claim 1 and further including a pneumatic fluid lock assembly disposed within said first chute member for preventing substantial air from entering said parts separator through said first chute member.

7. A parts separator in accordance with claim 1 and further including a pneumatic fluid lock assembly disposed adjacent to and outside of said first chute member.

8. The method of delivering wet chips materials to be separated into dry chips and fluid to a parts separator from different source of origin, the parts separator including:
a first chute member having a top portion and a bottom portion and including spaced open first and second chute ends;
said first end being adapted to receive wet chips to be centrifuged and said second end being adapted to be connected to a centrifugal parts separator;
a heavy material drop out opening disposed in said first chute member bottom portion;
said first chute member top having at least one opening disposed in said top portion; and
at least one second chute member having spaced open first and second ends, said first end of said second chute member being adapted to receive wet chips to be separated and said second chute member being attached to said first chute member at the location of said opening in said first chute top portion whereby wet chips in said second chute member are adapted to pass through said opening in said top portion and pass into said first chute member; the method comprising the steps of:
passing wet chip materials through said first and second chute members passing wet chips in said second chute member into said first member; and
conveying said wet chip materials from said first and second chute members to a centrifugal parts separator.

9. The method of claim 8 and further including the steps of:
conveying wet chips to be separated through a plurality of said second chute members;
delivering said wet chips from said second chute members to said first chute member though said openings in said top portion; and
delivering said we chips from said first chute member and said plurality of second chute members to the centrifugal separator where the wet chips are separated into dry chips and fluid.
